(19) United States
(12) Patent Application Publication
(10) Pub. No.: US 2007/0058482 A1
(43) Pub. Date: Mar. 15, 2007

(54) Syringe control device

(75) Inventor: Yi-Lung Lee, Taichung County (TW)

Correspondence Address: BACON & THOMAS, PLLC, 625 SLATERS LANE, FOURTH FLOOR, ALEXANDRIA, VA, 22314, US

(73) Assignee: TERA AUTOTECH CORPORATION, TAICHUNG HSIEN (TW)

(21) Appl. No.: 11/280,176

(22) Filed: Nov. 17, 2005

(30) Foreign Application Priority Data
Sep. 3, 2005 (TW) 94130448

(51) Int. Cl. B28C 5/00

(52) U.S. Cl. 366/15; 435/283.1

(57) ABSTRACT

A syringe control device includes a linear reciprocating mechanism and a syringe mechanism. The linear reciprocating mechanism has a power drive including an electric control unit and an actuation rod driven by the power drive to act a linear reciprocating motion. The actuation rod has a first contact portion provided with two electrically conductive contacts electrically connected to the electric control unit. The syringe mechanism has a syringe unit including a second contact portion made of electrically conductive material and corresponding to the first contact portion of the actuation rod. When the first contact portion of the actuation rod contacts the second contact portion during the linear reciprocating motion, a signal will be sent to the electric control unit for controlling the displacement of the actuation rod so as to further control the syringe amount of the syringe unit.

### BACKGROUND OF THE INVENTION

1. Field of the Invention

The present invention relates to a syringe control device and more particularly to such a syringe control device that controls the syringe amount accurately.

2. Description of the Related Art

A conventional solvent- or agent-mixing process uses a syringe to draw and to inject respectively various solvents or testing agents into a container, which is then shaken, so that the solvents or testing agents can be evenly mixed in the container. However, the drawing step is usually done by manual labor, which is inefficient, and a cleaning liquid has to be filled into the barrel of the syringe for washing the residual solvent or agent contained in the barrel before using the same syringe to draw another solvent or agent. Therefore, the conventional mixing process is time-consuming. In addition, since the drawing step and the injection step of the solvent or agent are done by manual labor, the amount of the solvent or agent that is drawn and injected can not be accurately controlled.

### SUMMARY OF THE INVENTION

The primary objective of the present invention is to provide a syringe control device that saves the working time.

Another objective of the present invention is to provide a syringe control device that can control the syringe amount accurately.

To achieve the above-mentioned objectives, a syringe control device provided by the present invention comprises a linear reciprocating mechanism and a syringe mechanism. The linear reciprocating mechanism has a power drive including an electric control unit and an actuation rod driven by the power drive to act a linear reciprocating motion. The actuation rod has a first contact portion provided with two electrically conductive contacts electrically connected to the electric control unit. The syringe mechanism has at least one syringe unit having a plunger with a second contact portion made of electrically conductive material and corresponding to the first contact portion of the actuation rod. When the first contact portion of the actuation rod contacts the second contact portion during the linear reciprocating motion, a signal will be sent to the electric control unit for controlling the displacement of the actuation rod so as to further control the syringe amount of the syringe unit.

### BRIEF DESCRIPTION OF THE DRAWINGS

FIG. 1 is a plan view of a preferred embodiment of the present invention.

FIG. 2 is a perspective view of a linear reciprocating mechanism according to the preferred embodiment of the present invention.

FIG. 3 is an exploded perspective view of the linear reciprocating mechanism according to the preferred embodiment of the present invention.

FIG. 4 is a partial sectional view of the linear reciprocating mechanism according to the preferred embodiment of the present invention.

FIGS. 5-7 are schematic views, showing the actions of the linear reciprocating mechanism according to the preferred embodiment of the present invention.

### DETAILED DESCRIPTION OF THE INVENTION

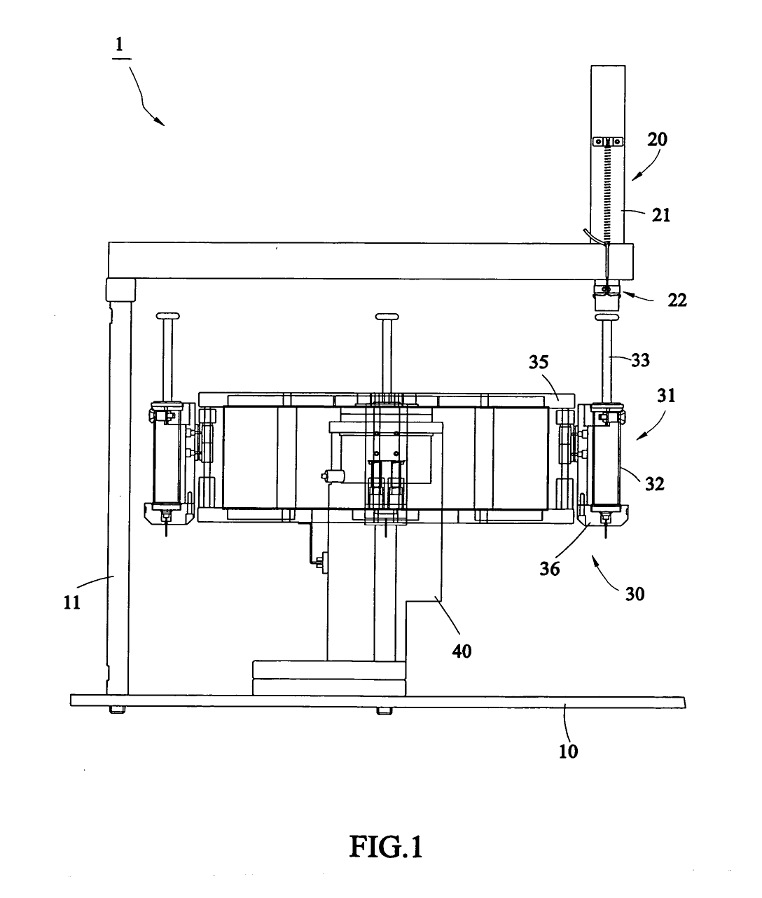

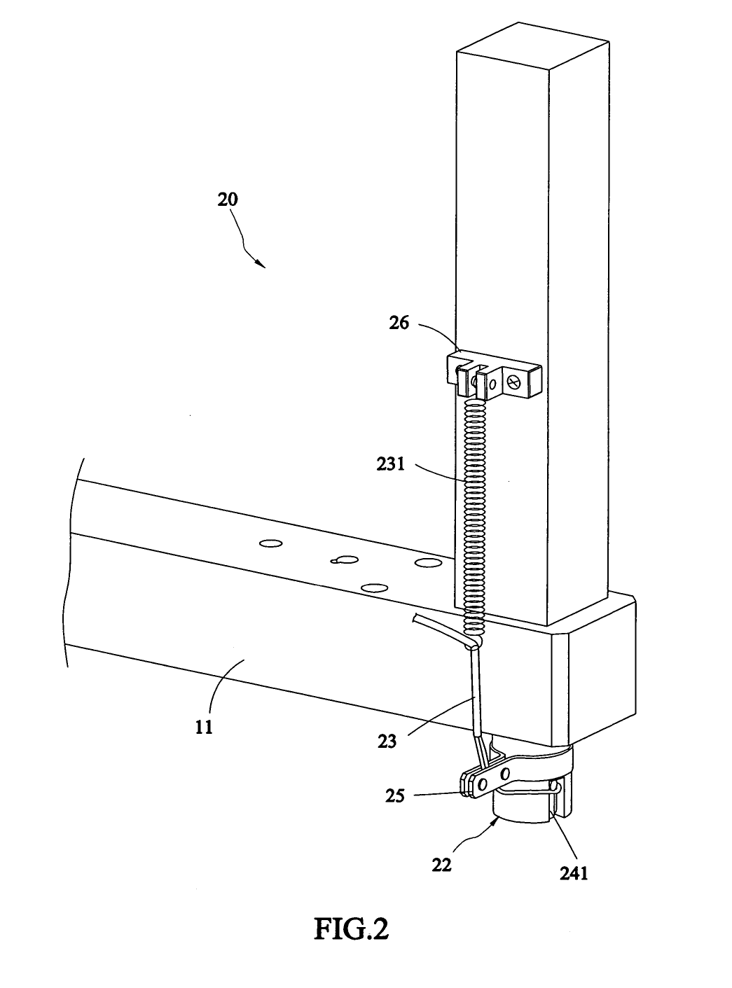

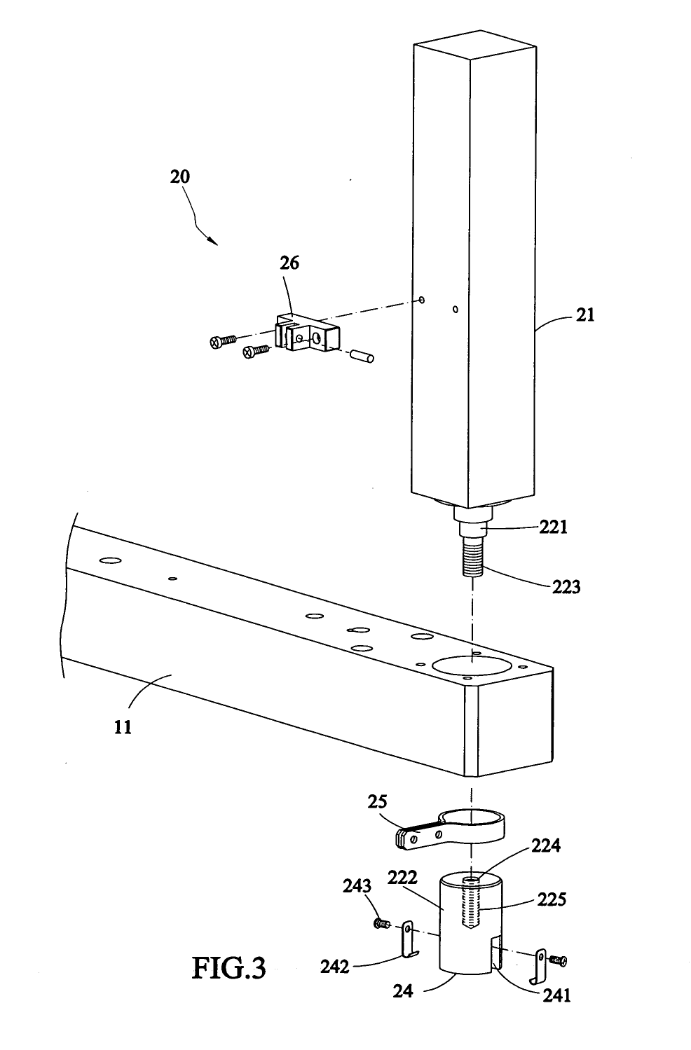

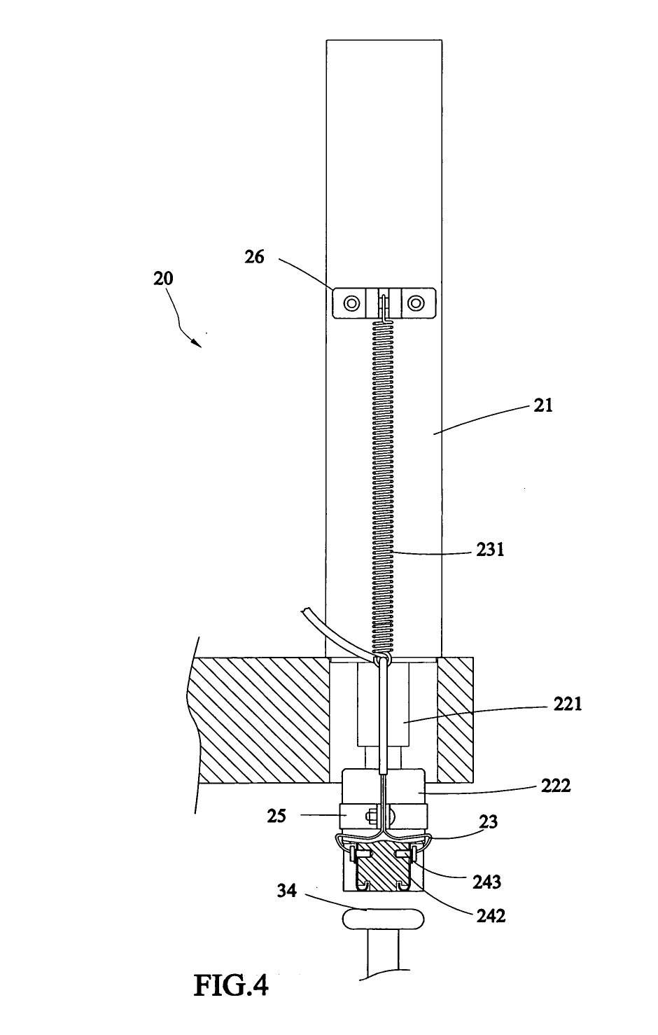

Referring to FIGS. 1-4, a syringe control device 1 in accordance with the preferred embodiment of the present invention is shown comprising a base 10, a supporting post 11, a linear reciprocating mechanism 20, and a syringe mechanism 30. As shown in FIG. 1, the supporting post 11 is an L-shaped rod having an end secured to the base 10, and the other end mounted with the linear reciprocating mechanism 20.

The linear reciprocating mechanism 20 has a body 21, a power drive (not shown) and an actuation rod 22. In the preferred embodiment of the present invention, the linear reciprocating mechanism 20 is a motored cylinder, that is, the body 21 is a hollow cylinder, the power drive is a motor mounted inside the body 21, and the actuation rod 22 is movably placed inside the body 21 and has a threaded structure screwed with the motor. It is easy to understand that the actuation rod 22 can be driven by the power drive to act a linear reciprocating motion. However, the linear reciprocating mechanism is not limited to the motored cylinder of the preferred embodiment of the present invention, that is, the linear reciprocating mechanism 20 can also be embodied as pneumatic cylinder, hydraulic cylinder or other applicable leaner reciprocating mechanism. In addition, the power drive has an electric control unit (not shown) and an electric connecting unit 23. The electric control unit controls operation of the power drive. The electric connecting unit 23, in this preferred embodiment, comprises two conducting wires electrically connected to the electric control unit. The actuation rod 22 that is movably mounted in the body 21 has a first portion 221 and a second portion 222. The first portion 221 has an end provided with an outer thread 223. The second portion 222 has a first end provided with a center hole 224 with an inner thread 225, such that the first portion 221 can be connected to the second portion 222 by engagement of the outer thread 223 of the first portion 221 into the inner thread 225 of the second portion 222. The second portion 222 has a second end having a first contact portion 24 provided at two sides thereof with a recess 241 respectively for receiving a respective electrically conductive contact 242 made of copper piece. The electrically conductive contacts 242 are fixed to the first contact portion 24 by two fasteners 243, which are screws in the present embodiment, and slightly protruded from the bottom of the first contact portion 24. In addition, the electrically conductive contacts 242 are electrically respectively connected to the conducting wires of the electric connecting unit 23.

A first holding member 25 is mounted on the body of the second portion 222 of the actuation rod 22, and a second holding member 26 is mounted on the body of the body 21 of the linear reciprocating mechanism. A tensile spring 231 has an end terminating as a hook hung on the second holding member 26. The total length of the tensile spring 231 without being subjected to any force is shorter than the distance between the first holding member 25 and the second holding member 26. The conducting wires of the electric connecting unit 23 each have an end electrically connected to one of the electrically conductive contacts 242, and the other end passing through the first holding member 25 and the hook of the other end of the tensile spring 231 and connecting electrically to the electric control unit. Because the electric connecting unit 23 is hung on the tensile spring 231 in a tensile manner, when the actuation rod 22 is driven by the power drive to act a downward linear movement, the electric connecting unit 23 will not fall down to tangle with the elements of the syringe mechanism 30, thereby preventing the electric connecting unit 23 from being broken.

The syringe mechanism 30 has a support seat 40 fixed on the base 10, a rotary disk 35 rotatably mounted on the support seat 40 and driven by a motor (not shown), a plurality of bearing members 36 surrounding the rotary disk 35, and a plurality of syringe units 31 each having a barrel 32 mounted respectively in the bearing members 36, and a plunger 33 having a first end 331 and a second end 332. The first end 331 of the syringe unit 31 is located in the barrel 32 and has the periphery thereof contacting on the inner wall of the barrel 32. The second end 332 of the syringe unit 31 protrudes from the barrel 32 and has a second contact portion 34 made of electrically conductive material. In the preferred embodiment of the present invention, the rotary disk 35 is rotatable relative to the support seat 40 reciprocally to move each of the syringe units 31 to a location under the linear reciprocating mechanism 20.

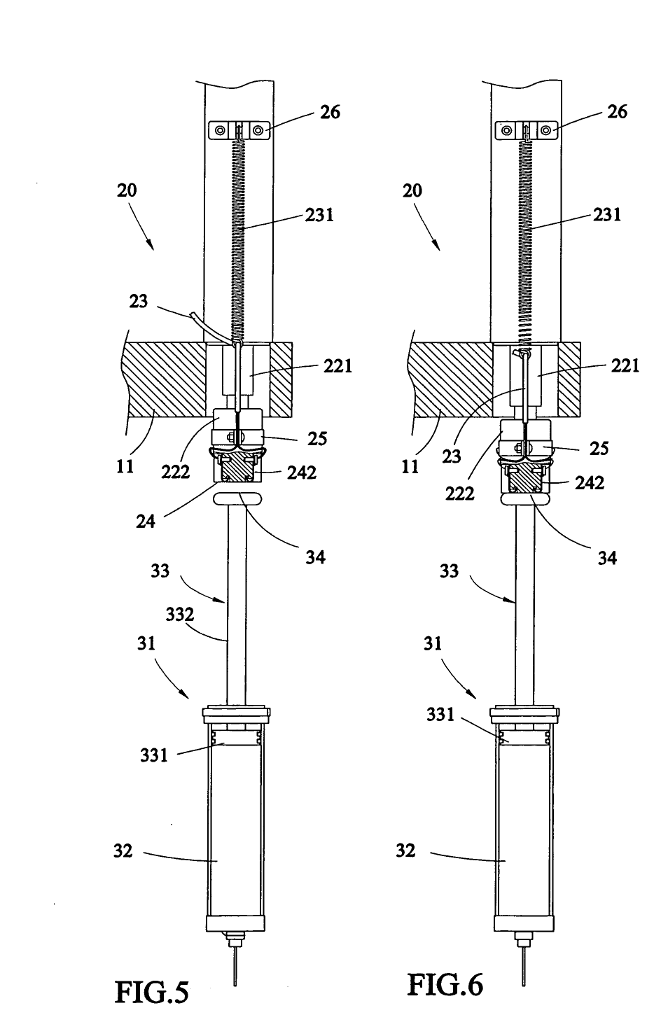

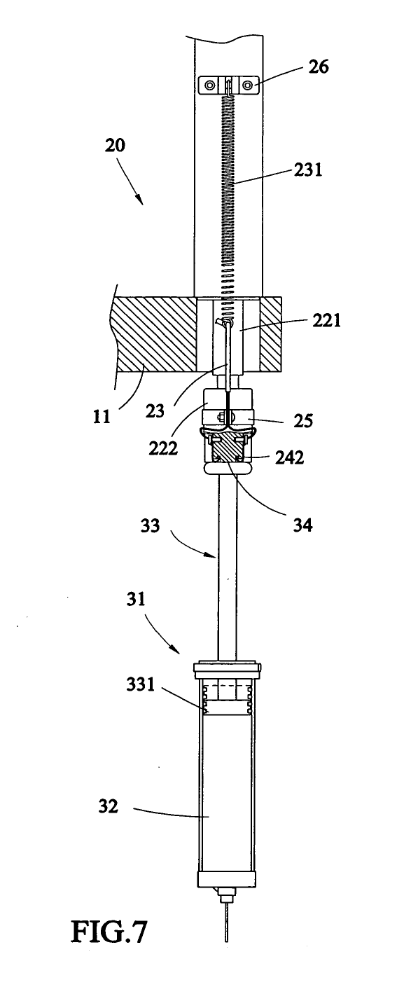

As shown in FIG. 5, a syringe unit 31 is moved to a location under the linear reciprocating mechanism 20. The actuation rod 22 is then driven by the power drive to act a downward linear movement, so that the electrically conductive contacts 242 of the first contact portion 24 contact the second contact portion 34 of the syringe unit 31 as shown in FIG. 6. At this time, the electrically conductive contacts 242 are conducted by the second contact portion 34 to form an electric ON status. This signal is then sent by the electric connecting unit 23 to the electric control unit for taking this contact point as a starting point of the syringe amount, and then the power drive will control downward displacement of the actuation rod 22 according to the required syringe amount. For example, if the syringe amount is 10 cubic units and the area of the barrel is 2 square units, the plunger of the barrel should be driven to move 5 units. In light of this, the linear reciprocating mechanism 20 will count 5 units of displacement during the down stroke of the actuation rod 22 as soon as the first contact portion 24 contacts the second contact portion 34.

As mentioned, the linear reciprocating mechanism 20 starts to count the required displacement of the actuation rod 22 after the electric control unit receives the contacting signal of the first contact portion 24 with the second contact portion 34. Therefore, the required displacement of the actuation rod 22 subject to each syringe unit 31 can be automatically calculated and controlled according to the elevation of the plunger 33 of each syringe unit 31, that is, the syringe amount of each syringe unit 31 can be controlled accurately. This overcomes the shortcoming of the manual work in which the syringe amount cannot be controlled accurately and saves the working time.

What is claimed is:

1. A syringe control device comprising:
a linear reciprocating mechanism, which has a power drive including an electric control unit and an actuation rod driven by the power drive to act a linear reciprocating motion, the actuation rod having a first contact portion provided with two electrically conductive contacts electrically connected to the electric control unit; and
a syringe mechanism located under the linear reciprocating mechanism and having at least one syringe unit including a barrel and a plunger, the plunger having a second contact portion made of electrically conductive material and corresponding to the first contact portion of the actuation rod.

2. The syringe control device as claimed in claim 1, wherein each of the two electrically conductive contacts is made of a copper piece.

3. The syringe control device as claimed in claim 1, wherein the syringe mechanism comprises a plurality of said syringe units each of which can be moved by rotation or linear reciprocating movement to a location corresponding to the first contact portion of the actuation rod.

4. The syringe control device as claimed in claim 1, wherein the linear reciprocating mechanism is a motored cylinder comprising a body formed of a hollow cylinder, the power drive formed of a motor mounted inside the body, and the actuation rod screwed with the motor and driven by the motor to act the linear reciprocating motion.

5. The syringe control device as claimed in claim 1, wherein the actuation rod comprises a first portion having an outer thread, and a second portion having a center hole with an inner thread screwed onto the outer thread of the first portion such that the first portion and the second portion are connected, the second portion having an end forming said first contact portion.

6. The syringe control device as claimed in claim 1, wherein the first contact portion is provided at two sides thereof with a recess respectively for receiving the two electrically conductive contacts, wherein the electrically conductive contacts are fixed to the first contact portion by two fasteners and slightly protruded from a bottom of the first contact portion.

7. The syringe control device as claimed in claim 4, wherein the electrically conductive contacts are electrically connected to the electric control unit by two conducting wires.

8. The syringe control device as claimed in claim 7, further comprising a first holding member mounted on the actuation rod, a second holding member mounted on the body of the motored cylinder, and a tensile spring has an end terminating as a hook hung on the second holding member and the other end terminating as a hook; wherein the total length of the tensile spring without extension is shorter than the distance between the first holding member and the second holding member; wherein the conducting wires each have an end electrically connected to one of the electrically conductive contacts, and the other end passing through the first holding member and the hook of the other end of the tensile spring and connecting electrically to the electric control unit

9. The syringe control device as claimed in claim 1, wherein the syringe mechanism has a rotary disk and a plurality of bearing members surrounding the rotary disk and holding a plurality of said syringe units.
